(19) United States
(12) Patent Application Publication
(10) Pub. No.: US 2015/0060514 A1
(43) Pub. Date: Mar. 5, 2015

(54) FIRING-OPERATION TOTALIZING DEVICE FOR A GAS NAIL GUN

(71) Applicant: BASSO INDUSTRY CORP., Taichung (TW)

(72) Inventors: An-Gi Liu, Taichung (TW); Chang-Sheng Lin, Taichung (TW)

(21) Appl. No.: 14/475,965

(22) Filed: Sep. 3, 2014

(30) Foreign Application Priority Data
Sep. 5, 2013 (TW) 102132018

(51) Int. Cl. B25C 1/08; B25C 7/00

(52) U.S. Cl. CPC B25C 1/08; B25C 7/00
USPC 227/9

(57) ABSTRACT

A firing-operation totalizing device for a gas nail gun includes two pressure areas, a pressure feedback unit mounted in a body, and an electric control unit. The pressure areas are constituted by an interior of a combustion chamber and an interior of a cylinder body. The pressure feedback unit outputs a pressure signal in response to each pressure change of at least one of the pressure areas. The electric control unit includes a control circuit that totalizes the number of the firing operations based on the pressure signals received thereby. As such, the totalized number of the firing operations is increased only when a pressure change of the at least one of the pressure areas occurs due to an explosion to totalize accurately the number of effective firing operations.

### CROSS-REFERENCE TO RELATED APPLICATION

This application claims priority of Taiwanese Application No. 102132018, filed on Sep. 5, 2013.

### BACKGROUND OF THE INVENTION

1. Field of the Invention

This invention relates to a counting device, and more particularly to a device for totalizing the number of the firing operations of a gas nail gun.

2. Description of the Related Art

Taiwanese Patent Publication No. 201242727 discloses a method for totalizing the number of the firing operations of a nail gun, in which a nail is struck by a high-pressure air produced due to explosion, and the number of the firing operations is totalized according to high-voltage discharge signals.

During operation of the gas nail gun, electricity is supplied from a battery set. However, since the gas nail gun includes a safety member for preventing misfiring, before a firing operation is performed, the electricity is supplied for activating the safety member if necessary. As such, the totalized number of the firing operations may be increased by one due to an inadvertent actuation of a trigger prior to operation of the safety member, or due to an actuation of the trigger prior to installation of a gas can. In other words, even if the nail gun is not fired, the totalized number of the firing operations may be increased due to unexpected high-voltage discharges, so that the number of the firing operations cannot be totalized accurately.

### SUMMARY OF THE INVENTION

The object of this invention is to provide a device that can totalize accurately the number of the firing operations of a nail gun.

According to this invention, a firing-operation totalizing device for a gas nail gun includes two pressure areas, a pressure feedback unit mounted in a body, and an electric control unit. The pressure areas are constituted by an interior of a combustion chamber and an interior of a cylinder body. The pressure feedback unit outputs a pressure signal in response to each pressure change of at least one of the pressure areas. The electric control unit includes a control circuit that totalizes the number of the firing operations based on the pressure signals received thereby. As such, the totalized number of the firing operations is increased only when a pressure change of the at least one of the pressure areas occurs due to an explosion to totalize accurately the number of effective firing operations.

### BRIEF DESCRIPTION OF THE DRAWINGS

These and other features and advantages of this invention will become apparent in the following detailed description of the embodiments of this invention, with reference to the accompanying drawings, in which:

FIG. 1 is a sectional view of a gas nail gun including the first embodiment of a firing-operation totalizing device according to this invention;

FIG. 2 is a fragmentary sectional view of the gas nail gun of FIG. 1;

FIG. 3 is a fragmentary sectional view of a gas nail gun including the second embodiment of a firing-operation totalizing device according to this invention;

FIG. 4 is a fragmentary schematic view of a pressure feedback unit of the second preferred embodiment;

FIG. 5 is a front view of the gas nail gun, illustrating one modified alarm member of the firing-operation totalizing device, which is configured as a light emitting member; and

FIG. 6 is a front view of the gas nail gun, illustrating another modified alarm member of the firing-operation totalizing device, which is configured as a display.

### DETAILED DESCRIPTION OF THE EMBODIMENTS

Before the present invention is described in greater detail in connection with the embodiments, it should be noted that similar elements and structures are designated by like reference numerals throughout the entire disclosure.

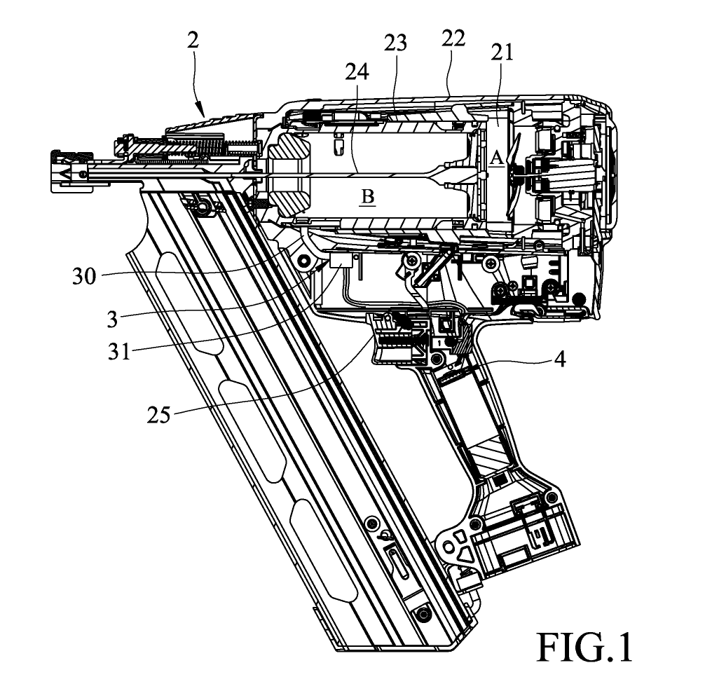

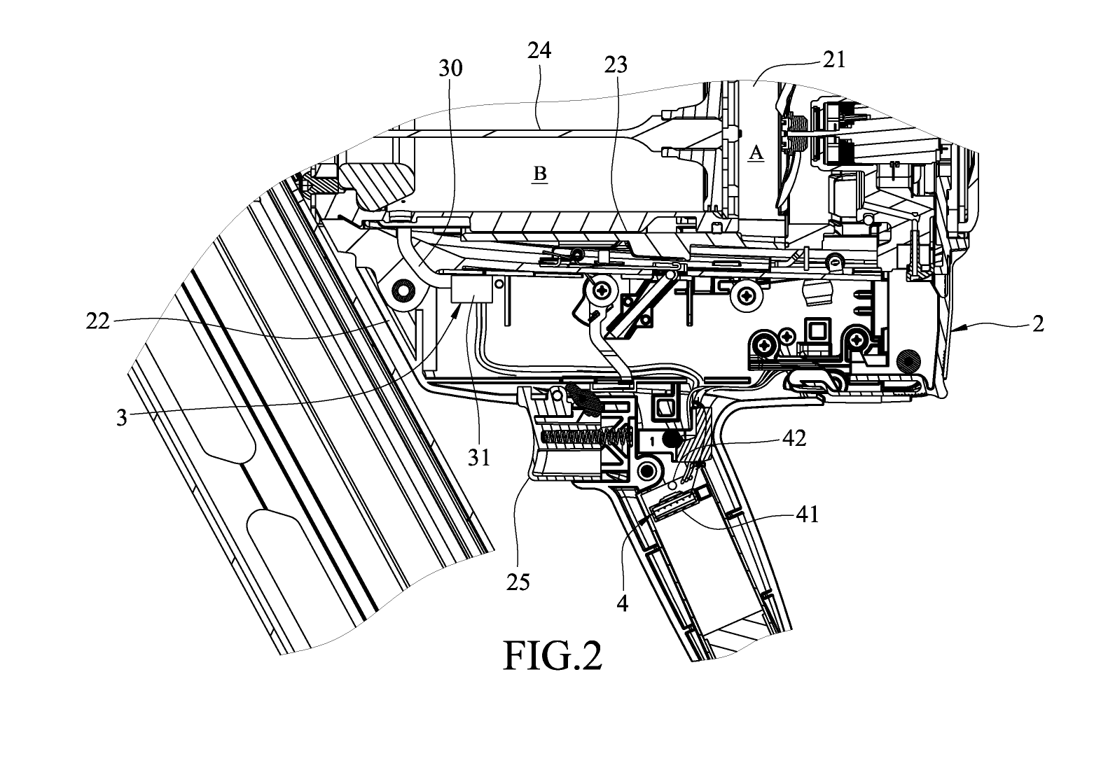

Referring to FIGS. 1 and 2, the first embodiment of a firing-operation totalizing device according to this invention is used in a gas nail gun 2. The gas nail gun 2 includes a body 22 defining a combustion chamber 21, a cylinder body 23 disposed in the body 22, a piston type impact member 24 contacting sealingly and extending outwardly from the cylinder body 23, and a trigger unit 25 disposed on the body 22 and operable for activating the piston type impact member 24. Upon an explosion in the combustion chamber 21, the piston type 24 is movable along the cylinder body 23 to perform a nail-striking operation (i.e., firing operation). The firing-operation totalizing device includes first and second pressure areas (A, B), a pressure feedback unit 3, and an electric control unit 4.

The first and second pressure areas (A, B) are constituted by an interior of the combustion chamber 21 and an interior of the cylinder body 23, respectively.

The pressure feedback unit 3 is mounted to the body 23. In this embodiment, the pressure feedback unit 3 includes an air conduit 30 in fluid communication with and extending outwardly from the second pressure area (B), and a pressure sensor 31 connected to the air conduit 30. The pressure sensor 31 measures a pressure (V) of air in the second pressure area (B) via the air conduit 30 to output a pressure signal. Alternatively, the air conduit 30 may be in fluid communication with and extend outwardly from the first pressure area (A), and the pressure sensor 31 is used to measure a pressure of air in the first pressure area (A) via the air conduit 30.

The electric control unit 4 is mounted to the body 22, and includes a control circuit 41 electrically connected to the pressure sensor 31, and an alarm member 42 electrically connected to the control circuit 41. The control circuit 41 has a preset threshold pressure value (V₀), and a preset number value (S₀), and totalizes the number (S) of the firing operations, which corresponds to the total number of the pressure signals. In this embodiment, the alarm member 42 is an audio warning device that can produce a warning message. In this embodiment, the message is a sound.

When the trigger unit 25 is actuated, the gas in the combustion chamber 21 is ignited to create an explosion. Upon explosion, the piston type impact member 24 is moved along the cylinder body 23 for striking a nail. Hence, air in the cylinder body 23 is compressed until the nail striking operation is completed.

When the trigger unit 25 is actuated, the pressure sensor 31 detects a pressure (V) and a pressure change in the second pressure area (B), so as to output the pressure signal to the control circuit 41. When receiving the pressure signal, the control circuit 41 judges whether or not the pressure (V) is greater than the preset threshold pressure value (V₀). If yes, the pressure change must be created due to one effective firing operation. At this time, since one effective firing operation is identified by the control circuit 41, the totalized number (S) of the firing operations is increased by one. When the totalized number (S) reaches the preset number value (S₀), the warning sound is produced by the alarm member 42 so that the user realizes that the totalized number (S) has reached the preset number value (S₀).

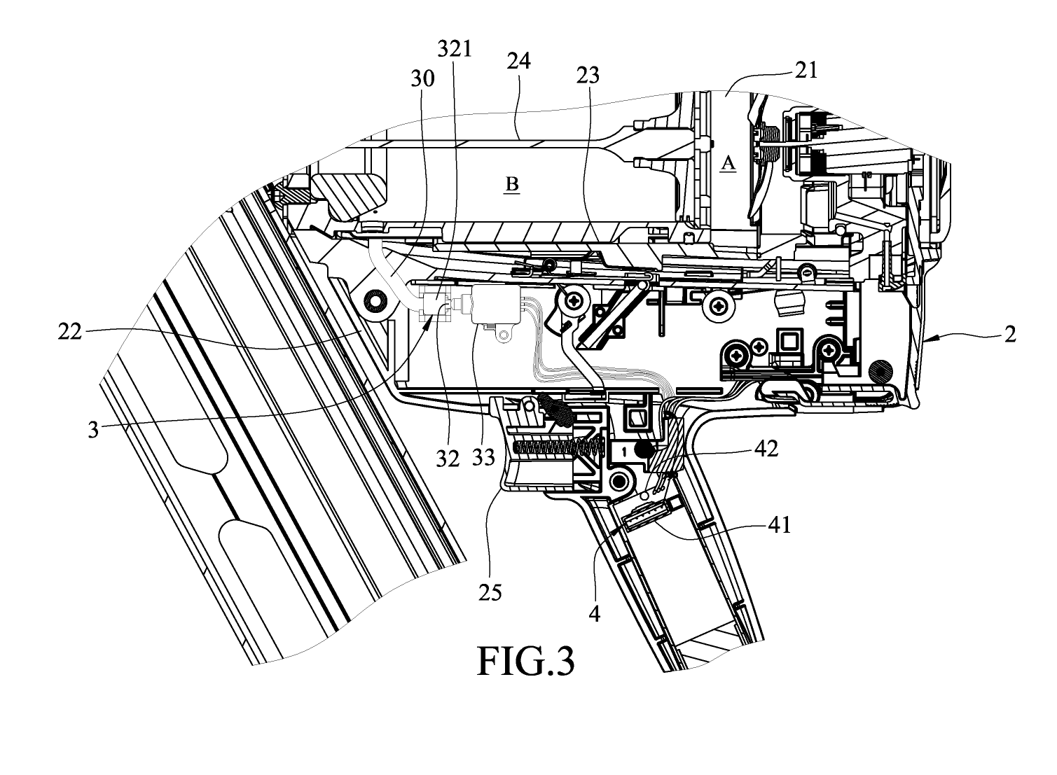

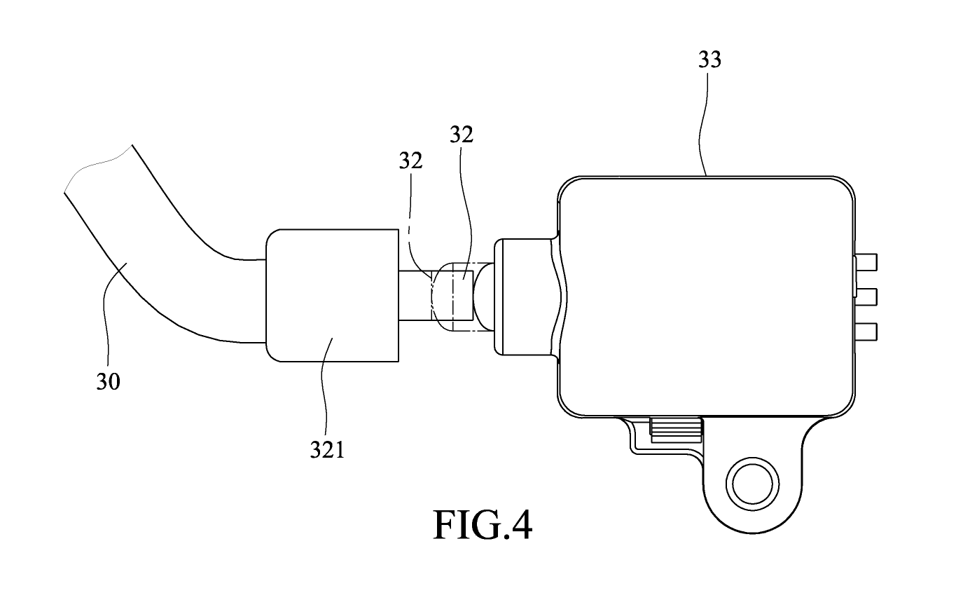

FIGS. 3 and 4 show the second embodiment of a firing-operation totalizing device according to this invention. Similar to the first embodiment, the second embodiment includes first and second pressure areas (A, B), a pressure feedback unit 3, and an electric control unit 4. Unlike the first preferred embodiment, the pressure feedback unit 3 includes a movable member 32, and a trigger switch 33 disposed outside the second pressure area (B) and electrically connected to the control circuit 41. The pressure feedback unit 3 further includes a seat body 121 connected to the air conduit 30. The movable member 32 is configured as a piston rod that is movable on the seat body 321 to contact the trigger switch 33. The trigger switch 33 may be a proximity switch or a microswitch, which outputs a pressure signal when contacted.

When the pressures in the first and second pressure areas (A, B) increase as a result of explosion in the combustion chamber 21 and movement of the piston type impact member 24, the piston rod 32 is driven by compressed air in the second pressure area (B) to move to thereby contact the trigger switch 33 for outputting the pressure signal. Consequently, each pressure signal corresponds to one effective firing operation, so that the number (S) of the firing operations can be totalized accurately.

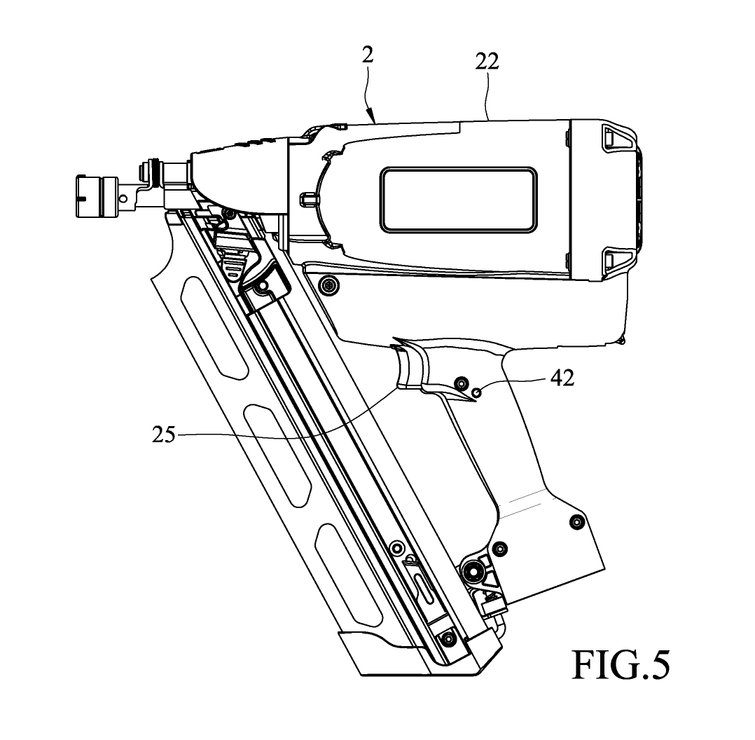

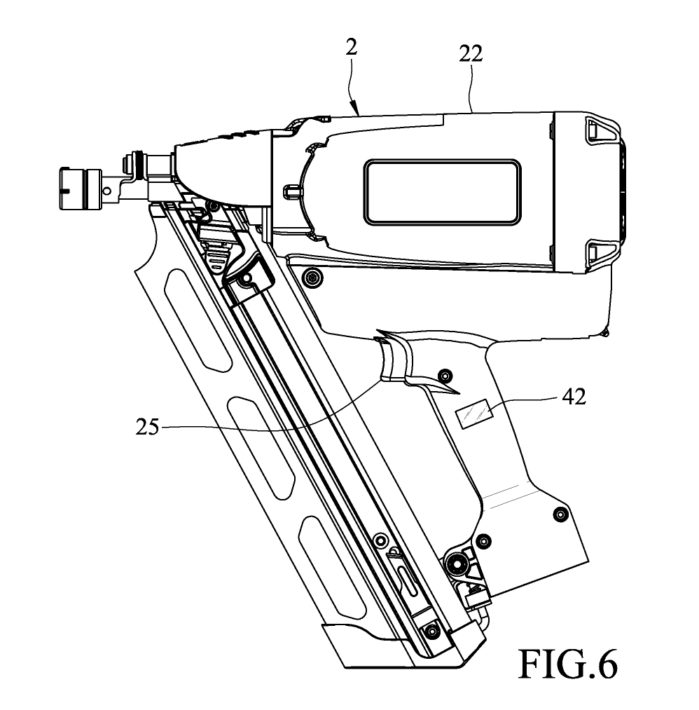

It is worth noting that, the alarm member 42 of each abovementioned embodiment may be a light emitting member (see FIG. 5), or a display (see FIG. 6). In this case, when the number (S) of the firing operations reaches the preset number value (S₀), the control circuit 41 controls the alarm member 42 to emit light or produce an image (e.g., of numerals) for warning.

To sum up, the firing-operation totaling device of this invention has the following advantage:

This invention takes pressure changes in the first and second pressure areas (A, B) as judgment source of the number (S) of the firing operations. Since pressures in the first and second pressure areas (A, B) can change only when explosions occur in the combustion chamber 21 to move the piston type impact member 24. As a result, the number (S) of the firing operations can be totalized accurately.

With this invention thus explained, it is apparent that numerous modifications and variations can be made without departing from the scope and spirit of this invention. It is therefore intended that this invention be limited only as indicated by the appended claims.

What is claimed is:

1. A firing-operation totalizing device adapted for use in a gas nail gun, the gas nail gun including a body defining a combustion chamber, a cylinder body disposed in the body, and a piston type impact member contacting sealingly the cylinder body and extending outwardly from the cylinder body, the piston type impact member being movable in the cylinder body for performing a nail striking operation in response to explosion in the combustion chamber, said firing-operation totalizing device comprising:
two pressure areas adapted to be constituted by an interior of the combustion chamber and an interior of the cylinder body, respectively;
a pressure feedback unit adapted to be mounted in the body for outputting a pressure signal in response to each of pressure changes of at least one of said pressure areas that corresponds to one effect firing operation of the gas nail gun; and
an electric control unit adapted to be mounted in the body and including a control circuit that is electrically connected to said pressure feedback unit for totalizing a number of the effective firing operations based on the pressure signals produced in response to the pressure changes of said at least one of said pressure areas.

2. The firing-operation totalizing device as claimed in claim 1, wherein said pressure feedback unit includes a pressure sensor electrically connected to said control circuit, said pressure sensor being disposed for measuring a pressure in said at least one of said pressure areas to output the pressure signal, said control circuit having a preset threshold pressure value such that, when the pressure in the at least one of said pressure areas is greater than the preset threshold pressure value, one effective firing operation is identified by said control circuit to increase the number of the effective firing operations when totalized.

3. The firing-operation totalizing device as claimed in claim 2, wherein said pressure feedback unit further includes an air conduit in fluid communication with and extending outwardly from said at least one of said pressure areas and connected to said pressure sensor.

4. The firing-operation totalizing device as claimed in claim 1, wherein said pressure feedback unit includes a movable member, and a trigger switch disposed outside said pressure areas and electrically connected to said control circuit, said movable member being drivable pneumatically by one of the pressure changes of said at least one of said pressure areas to move into contact with said trigger switch, so that said trigger switch outputs the pressure signal, said control circuit totalizing the number of the effective firing operations that correspond to total number of the pressure signals received thereby.

5. The firing-operation totalizing device as claimed in claim 4, wherein said pressure feedback unit further includes an air conduit in fluid communication with and extending outwardly from said at least one of said pressure areas, and a seat body connected to said air conduit, said movable member being configured as a piston rod that is movable on said seat body and that is driven pneumatically by the pressure in said at least one of said pressure areas to move into contact with said trigger switch so that said trigger switch outputs the pressure signal.

6. The firing-operation totalizing device as claimed in claim 1, wherein said electric control unit further includes an alarm member electrically connected to said control circuit, said alarm member producing a warning message corresponding to a total number of the effective firing operations.

7. The firing-operation totalizing device as claimed in claim 6 wherein said alarm member is configured as an audio warning device that produces a sound when the total number of the effective firing operations reaches a preset number value.

8. The firing-operation totalizing device as claimed in claim 6, wherein said alarm member is configured as a video warning device that produces an image when the total number of the effective firing operations reaches a preset number value.

9. The firing-operation totalizing device as claimed in claim 6, wherein said alarm member is configured as a light emitting member that emits light when the total number of the effective firing operations reaches a preset number value.
